(19) United States
(12) Patent Application Publication
(10) Pub. No.: US 2021/0158032 A1
(43) Pub. Date: May 27, 2021

(54) SYSTEM, APPARATUS AND METHOD FOR RECOGNIZING MOTIONS OF MULTIPLE USERS

(71) Applicant: ELECTRONICS AND TELECOMMUNICATIONS RESEARCH INSTITUE, Daejeon (KR)

(72) Inventors: Seong Min BAEK, Daejeon (KR); Youn Hee GIL, Daejeon (KR); Hee Kwon KIM, Daejeon (KR); Hee Sook SHIN, Daejeon (KR); Cho Rong YU, Daejeon (KR); Sung Jin HONG, Incheon (KR)

(21) Appl. No.: 17/096,296

(22) Filed: Nov. 12, 2020

(30) Foreign Application Priority Data
Nov. 25, 2019 (KR) 10-2019-0152780

(51) Int. Cl. G06K 9/00

(52) U.S. Cl. CPC G06K 9/00362

(57) ABSTRACT

A method of recognizing motions of a plurality of users through a motion recognition apparatus includes acquiring a plurality of depth images from a plurality of depth sensors disposed at different positions, extracting user depth data corresponding to a user area from each of the plurality of depth images, allocating a label ID of each user to the extracted user depth data; matching the label ID for each frame of the depth images, and tracking a joint position for the user depth data on the basis of a result of the matching.

### CROSS-REFERENCE TO RELATED APPLICATION

This application claims priority to and the benefit of Korean Patent Application No. 10-2019-0152780, filed on Nov. 25, 2019, the disclosure of which is incorporated herein by reference in its entirety.

### BACKGROUND

### 1. Field of the Invention

The present invention relates to a system, apparatus, and method for recognizing motion of a plurality of users using a depth image through a plurality of depth sensors.

### 2. Description of Related Art

A technique for acquiring a three-dimensional (3D) posture of a human body from a depth image (a depth map) has recently become increasingly important due to interactive content. Such posture recognition techniques can accurately analyze a user's posture to improve his or her exercise ability or aid in effective exercise learning.

However, a system for gesture recognition (natural user interface (NUI) for user interaction (e.g., Microsoft Kinect) cannot restore a 3D posture when a human body overlaps or rotates. Also, even when multiple users are moving, there is a problem in that it is difficult to continuously track the users because they overlap each other.

### SUMMARY OF THE INVENTION

The present invention is directed to providing a motion recognition system, apparatus, and method capable of, when multiple users are moving, minimizing overlaps between joints due to their own movements and the others' movements and tracking user IDs in real time to continuously recognize three-dimensional (3D) postures by using a plurality of cheap depth sensors.

However, the technical object to be achieved by the present embodiment is not limited to the above-mentioned technical object, and other technical objects may be present.

According to a first aspect of the present invention, there is provided a method of recognizing motions of a plurality of users through a motion recognition apparatus, the method including acquiring a plurality of depth images from a plurality of depth sensors disposed at different positions, extracting user depth data corresponding to a user area from each of the plurality of depth images, allocating a label ID to the extracted user depth data on a user basis, matching the label ID for each frame of the depth images, and tracking a joint position for the user depth data on the basis of a result of the matching.

Also, according to a second aspect of the present invention, there is provided an apparatus for recognizing motions of a plurality of users, the apparatus including a plurality of depth sensors disposed at different positions and configured to acquire a depth image, a memory configured to store a program for recognizing a user's motion from the plurality of depth images, and a processor configured to execute the program stored in the memory. In this case, by executing the program stored in the memory, the processor extracts user depth data corresponding to a user area from each of the plurality of depth images, allocates a label ID to the extracted user depth data on a user basis, matches the label ID for each frame of the depth images, and tracks a joint position of the user depth data on the basis of a result of the matching.

Also, according to a third aspect of the present invention, there is provided a system for recognizing motions of a plurality of users, the system including a sensor unit configured to acquire a plurality of depth images from a plurality of depth sensors disposed at different positions and extract user depth data corresponding to a user area from each of the plurality of depth images, an ID tracking unit configured to allocate a label ID to the extracted user depth data on a user basis and match the label ID for each frame of the depth images, and a 3D motion recognition unit configured to track a joint position of the user depth data in the order of a head part, a body part, and a limb part on the basis of a result of the matching.

A computer program according to the present invention for solving the above-described problems is combined with a computer, which is hardware, to execute the motion recognition method and is stored in a medium.

In addition, other methods and systems for implementing the present invention and a computer-readable recording medium having a computer program recorded thereon to execute the methods may be further provided.

Other specific details of the present invention are included in the detailed description and accompanying drawings.

According to an embodiment, it is possible to distinguish multiple users and track their IDs using depth data in real time, and also it is possible to continuously estimate three-dimensional (3D) postures even when a user is moving or rotating.

Also, it is possible to expect higher speed and accuracy than the conventional iterative closest point (ICP) algorithm schemes.

In particular, it is possible for multiple users to experience immersive programs such as virtual sports games and virtual reality (VR) experience games without the inconvenience of wearing markers or sensors.

Also, it is easy to increase sensor expandability, and it is possible to provide experiences in a wide space.

Technical solutions of the present invention are not limited to the aforementioned solution, and other solutions which are not mentioned here can be clearly understood by those skilled in the art from the following description.

### BRIEF DESCRIPTION OF THE DRAWINGS

FIG. 1 is a diagram illustrating a motion recognition system according to an embodiment of the present invention.

FIG. 2 is a diagram illustrating a motion recognition apparatus according to an embodiment of the present invention.

FIG. 3 is a flowchart illustrating a motion recognition method according to an embodiment of the present invention.

FIG. 4 is a diagram showing an example in which a plurality of depth sensors are disposed.

FIG. 5 is an exemplary diagram illustrating a height at which a depth sensor is installed.

FIG. 6 is a diagram illustrating a process of transforming a coordinate system for user depth data.

FIG. 7 is a diagram illustrating a ground grid splitting scheme.

FIG. 8 is an exemplary diagram illustrating a volume sampling process.

FIG. 9 is a diagram showing an example of a limb part model and a body part model.

FIG. 10A and 10B is an exemplary diagram of a result of extracting feature points.

FIG. 11 is a diagram illustrating a method of predicting a head part position.

FIG. 12 is a diagram illustrating an operation of determining a shoulder position.

FIG. 13 is a diagram illustrating a plurality of layers in a body part.

FIG. 14 is a diagram illustrating a hip position.

FIG. 15 is a diagram illustrating a point search process using an iterative closest point (ICP) algorithm.

FIG. 16 is a diagram illustrating an operation of determining a joint position by repeating an ICP algorithm multiple times.

FIG. 17 is a diagram showing an example of a result of recognizing a user's motion.

### DETAILED DESCRIPTION OF EXEMPLARY EMBODIMENTS

Advantages and features of the present invention and implementation methods thereof will be clarified through the following embodiments described in detail with reference to the accompanying drawings. However, the present invention is not limited to embodiments disclosed herein and may be implemented in various different forms. The embodiments are provided for making the disclosure of the present invention thorough and for fully conveying the scope of the present invention to those skilled in the art. It is to be noted that the scope of the present invention is defined by the claims.

The terminology used herein is for the purpose of describing particular embodiments only and is not intended to be limiting to the invention. As used herein, the singular forms “a,” “an,” and “one” include the plural unless the context clearly indicates otherwise. The terms “comprises” and/or “comprising” used herein specify the presence of stated elements but do not preclude the presence or addition of one or more other elements. Like reference numerals refer to like elements throughout the specification, and the term “and/or” includes any and all combinations of one or more of the associated listed items. It will be also understood that, although the terms first, second, etc. may be used herein to describe various elements, these elements should not be limited by these terms. These terms are only used to distinguish one element from another. Thus, a first element could be termed a second element without departing from the technical spirit of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention relates to a system 10, apparatus 20, and method for recognizing motions of a plurality of users.

Recently, various techniques for tracking a user's posture using a depth image have been developed and used.

As an example, in the case of room-scale virtual reality (VR), a user can experience VR content by holding a sensor in his or her hand while wearing a head-mounted display (HMD). However, in most cases, only movements of some body parts such as a head and a hand are recognized.

In addition, a method of estimating a joint position using acceleration from an inertial measurement unit (IMU) sensor or an optical motion capture apparatus for recognizing a marker attached to a user's body is mainly used for elite sports or precise medical equipment and is not suitable for being applied to experience content because a user has to wear a costume and have markers attached to his or her body and also because the method and the apparatus are expensive for general users to use.

Meanwhile, techniques for restoring a user's gesture using multiple depth sensors (Kinect, etc.) have been announced at the thesis level. However, most of the techniques apply only simple gestures for one user as a test, apply only some joints, such as joints in an upper body, or do not operate in real time.

In addition, most studies on estimating postures using an iterative closest point (ICP) algorithm also have a slow computation time and can estimate only some joints, such as joints in an upper body.

In recent papers, a technique for acquiring multiple gestures with a single image camera by introducing a deep learning technique has been announced. However, the technique is applied to a two-dimensional image and does not distinguish users, and thus non-continuous joint data is generated for each frame. Furthermore, the technique requires a very large amount of computation so as to find a user's posture and thus needs to have high-spec hardware and also have learning data that is created in advance.

On the other hand, with the system 10, apparatus 20, and method for recognizing motions of a plurality of users according to an embodiment of the present invention, it is possible to continuously track a user's 3D dynamic postures in real time even when the user overlaps other users while they are moving as well as when the user overlaps himself or herself.

In particular, according to an embodiment of the present invention, there is no need for preliminary work such as the acquisition of learning data or gesture data, and there is no need to attach markers (marker free). Accordingly, it is possible to conveniently acquire a user's posture.

In addition, since only a depth image is required, gesture restoration is possible without using a specific depth sensor. Therefore, various depth sensors can be used interchangeably.

Hereinafter, embodiments of the present invention will be described in detail with reference to the accompanying drawings.

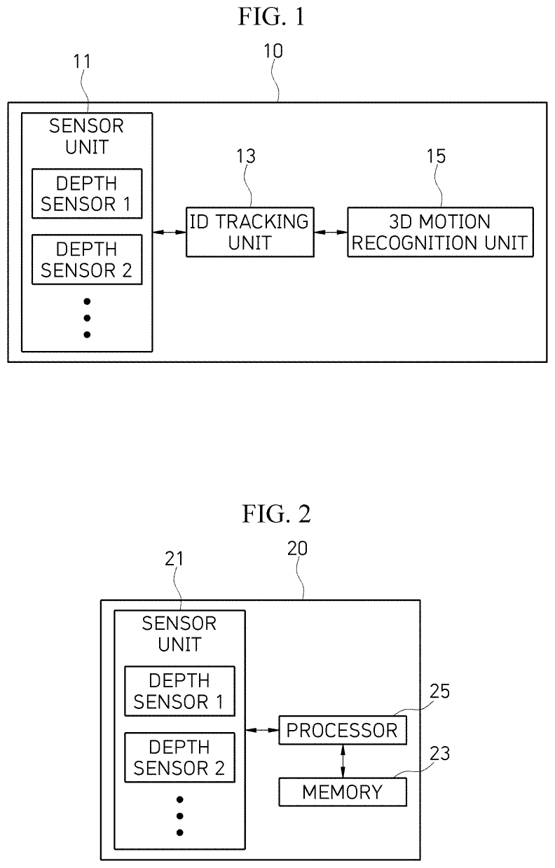

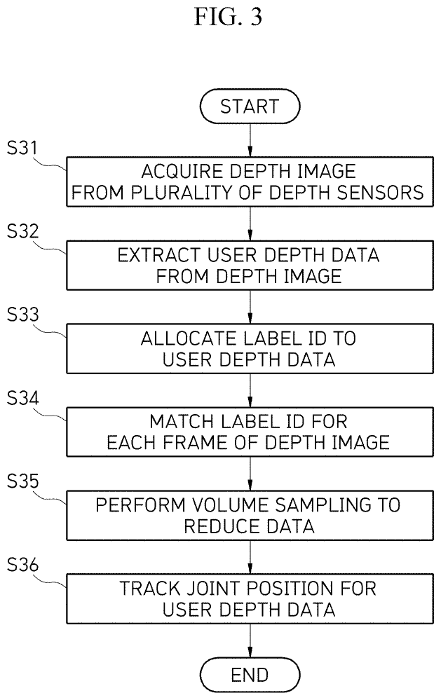

FIG. 1 is a diagram illustrating a motion recognition system 10 according to an embodiment of the present invention. FIG. 2 is a diagram illustrating a motion recognition apparatus 20 according to an embodiment of the present invention.

Referring to FIG. 1, the motion recognition system 10 according to an embodiment of the present invention includes a sensor unit 11, an ID tracking unit 13, and a 3D motion recognition unit 15.

The sensor unit 11 acquires a plurality of depth images from a plurality of depth sensors disposed at different positions.

Also, the sensor unit 11 extracts user depth data corresponding to a user area from the plurality of depth images.

In addition, the sensor unit 11 may transform the user depth data into a virtual coordinate system so that data processing is possible.

The ID tracking unit 13 matches a label ID to the user depth data extracted by the sensor unit 11 on a user basis.

The 3D motion recognition unit 15 tracks joint positions of the user depth data in the order of a head part, a body part, and a limb part on the basis of the matching result of the ID tracking unit 13.

Meanwhile, the motion recognition apparatus 20 according to an embodiment of the present invention may include a memory 23 and a processor 25 configured as the ID tracking unit 13 and the 3D motion recognition unit 15 in addition to the plurality of depth sensors 21. Also, if necessary, the motion recognition apparatus may additionally have a communication module (not shown).

A program for recognizing a user's motion from a plurality of depth images may be stored in the memory 23, and the processor 25 may perform functions of the ID tracking unit 13 and the 3D motion recognition unit 15 by executing the program stored in the memory 23.

Here, the memory 23 collectively refers to a non-volatile storage device, which maintains stored information even when no power is supplied, and a volatile storage device.

For example, the memory 23 may include a NAND flash memory such as a compact flash (CF) card, a secure digital (SD) card, a memory stick, a solid-state drive (SSD), or a micro SD card, a magnetic computer memory device such as a hard disk drive (HDD), and an optical disc drive such as a compact disc (CD)-read only memory (ROM) or a digital versatile disc (DVD)-ROM.

For reference, the elements illustrated in FIGS. 1 and 2 according to an embodiment of the present invention may be implemented as software or hardware such as a field-programmable gate array (FPGA) or an application-specific integrated circuit (ASIC) and may perform predetermined roles.

However, the elements are not limited to software or hardware and may be configured to be in an addressable storage medium or configured to activate one or more processors.

Accordingly, as an example, the elements include elements such as software elements, object-oriented software elements, class elements, and task elements, processes, functions, attributes, procedures, subroutines, program code segments, drivers, firmware, microcode, circuits, data, database, data structures, tables, arrays, and variables.

Elements and functions provided by corresponding elements may be combined into a smaller number of elements or may be divided into additional elements.

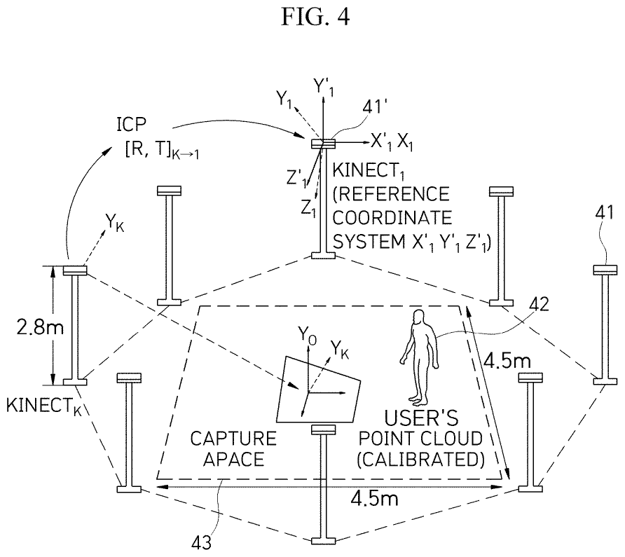

A method performed by the motion recognition system 10 and the motion recognition apparatus 20 according to an embodiment of the present invention will be described in detail below with reference to FIGS. 3 to 16.

FIG. 3 is a flowchart illustrating a motion recognition method according to an embodiment of the present invention.

The motion recognition method according to an embodiment of the present invention includes acquiring a plurality of depth images from a plurality of depth sensors disposed at different positions (S31).

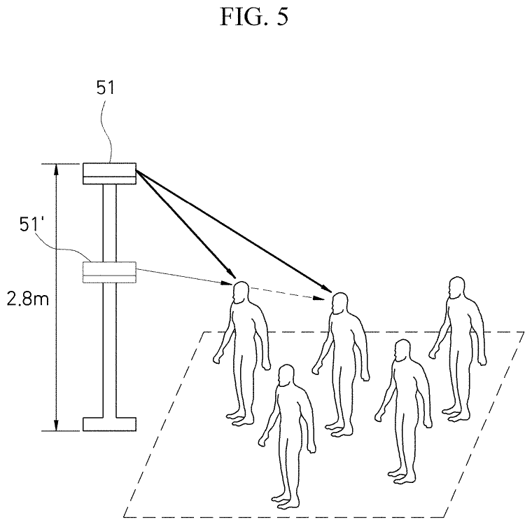

FIG. 4 is a diagram showing an example in which a plurality of depth sensors 41 are disposed.

In an embodiment, the plurality of depth sensors 41 may be installed near a space 43 for capturing a posture of a user 42 to track movement of the user 42.

In this case, the depth sensors 41 have different coordinate systems. Thus, according to an embodiment of the present invention, it is possible to compute a rotation and translation matrix [R, T] utilizing an ICP algorithm to match the coordinate systems of the plurality of depth sensors 41 to a coordinate system of a depth sensor 41′, which is one of the plurality of depth sensors 41.

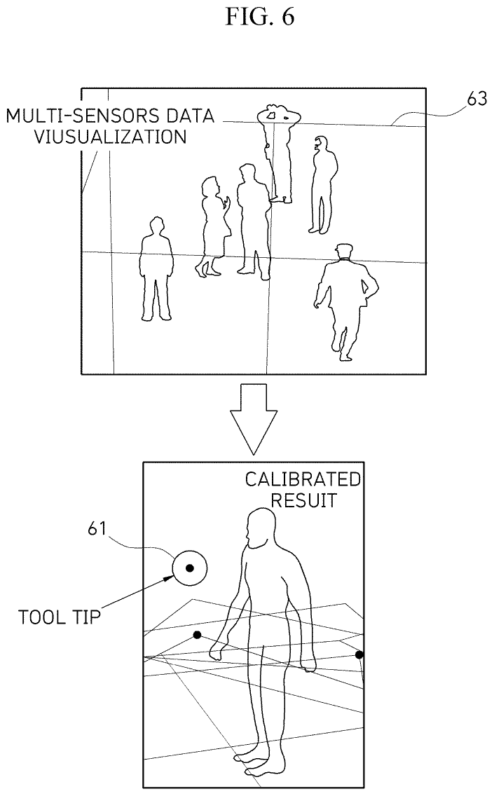

FIG. 5 is an exemplary diagram illustrating a height at which a depth sensor 51 is installed.

It is preferable that the plurality of depth sensors be installed at a height which minimizes an overlap between users in a space for capturing a user's posture.

For example, when a depth sensor 51′ is installed at a low height, more overlaps may occur between users. Therefore, it is preferable that depth sensors be installed at a height capable of preventing overlaps as much as possible. However, when a depth sensor 51′ is installed too high, data may not be acquired from a lower body well, and thus it is preferable to install the depth sensor 51′ at a certain height greater than or less than that of a normal person.

When a depth sensor is installed higher than the height of a person, as described above, the depth sensor may be tilted toward the ground. Therefore, a process of correcting the tilting of the depth sensor on the basis of the depth data of the ground is necessary.

That is, according to an embodiment of the present invention, as shown in FIG. 4, a process of aligning the normal value Yₖ of the depth data of the ground to a Y₀-axis of global coordinates may be additionally performed.

Meanwhile, an embodiment of the present invention is characterized in that a plurality of depth sensors are installed. In this case, there are no limitations on the types, number, positions, and the like of depth sensors, but it is preferable that there be no blind spot if possible.

Referring to FIG. 3 again, the motion recognition method includes extracting user depth data corresponding to a user area from a plurality of depth images (S32).

That is, only depth data Pu corresponding to a user may be extracted from a depth image input from a depth sensor.

In this case, according to an embodiment of the present invention, a process of transforming the user depth data into a virtual coordinate system may be additionally performed so that data processing is possible.

In an embodiment, after the process of performing transformation into the virtual coordinate system or the process of correcting the tilting of the depth sensor is performed, a process of transforming the coordinate system for the user depth data may be performed.

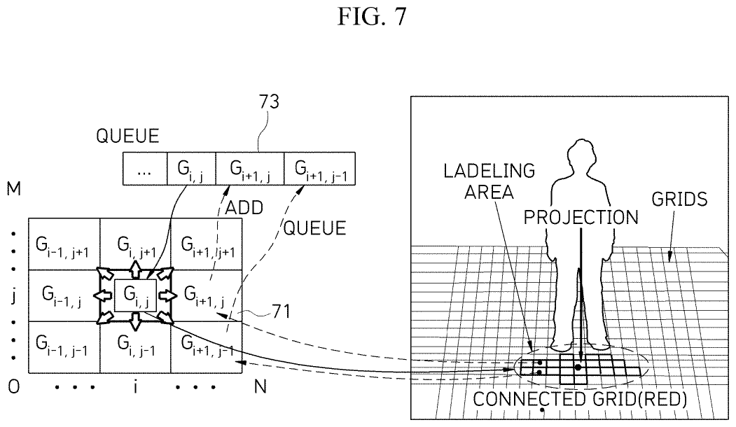

FIG. 6 is a diagram illustrating a process of transforming a coordinate system for user depth data.

According to an embodiment of the present invention, a calibration process for matching the coordinate systems for the user's depth data may be performed.

In this process, when the user moves in a space 63 for capturing a user's posture with a calibration tool 61, each depth sensor stores the average position of depth data of the tool 61 during T frames. Subsequently, a transformation matrix (a translation and rotation matrix) may be calculated based on the ICP algorithm to match the coordinate systems.

Referring to FIG. 3 again, since the user depth data extracted from the depth image is not classified on a user basis, the motion recognition method includes classifying the extracted user depth data on a user basis, i.e., allocating a label ID to the extracted user depth data on a user basis (S33).

In an embodiment, according to the present invention, a ground grid splitting scheme may be applied for classification of the user depth data.

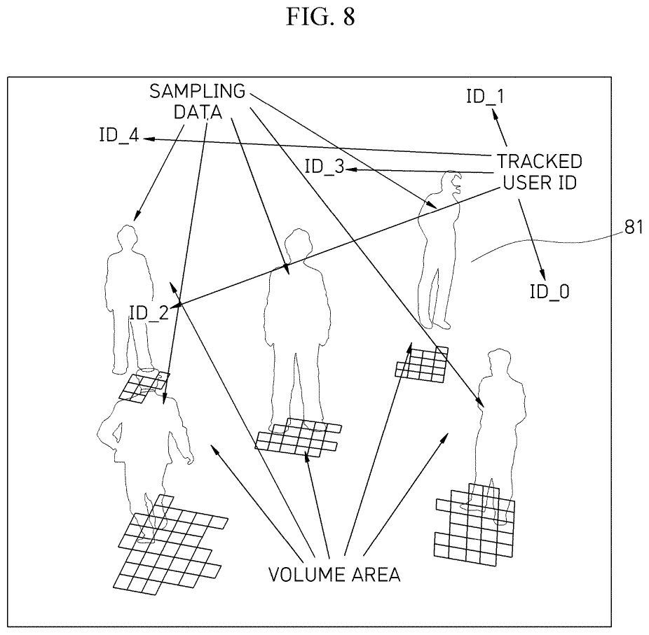

FIG. 7 is a diagram illustrating the ground grid splitting scheme.

According to an embodiment of the present invention, first, the ground is split into a plurality of grids 71. That is, the ground is split into N×M grids 71.

Subsequently, each point Puᵢ of the user depth data is projected onto the ground, and the points are allocated to corresponding grids 71 when the points are projected onto the ground.

When the grid allocation process for all the points of the user depth data is completed, a grid search is performed in the first order. When a grid including a point Pᵢ is found, the corresponding grid is stored in a queue storage 73.

In this case, when the grids 71 are input to the queue storage 73, the search process is temporarily paused.

Also, one grid 71 is taken out from the queue storage 73, and a grid including the point among grids adjacent to the corresponding grid is stored in the queue storage 73.

For example, as shown in FIG. 7, when a grid G_{i, j} is first stored in the queue storage 73, a search for grids near the corresponding grid is performed first. Among the grids, grids G_{i+1, j} and G_{i+1, j-1}, each of which includes a point, are stored in the queue storage.

Thus, the grids G_{i, j}, G_{i+1, j}, and G_{i+1, j-1} are stored in the queue storage 73. Since the search process for grids near the grid G_{i, j}, is completed, a search for grids adjacent to the second-stored grids G_{i+1, j} and G_{i+1, j-1} is performed.

When a search for all of the grids included in the queue storage 73 is completed according to the above process, a search for other grids is performed. In this case, the grids included in the queue storage 73 are excluded.

Also, the same label ID is allocated to the grids stored in the queue storage 73.

When this process is repeatedly executed, it is possible to classify the input depth data on a user basis as indicated by a red grid in FIG. 7 (pu→pu_k, where k is each user).

Referring to FIG. 3 again, subsequently, the motion recognition method includes matching a label ID for each frame of the depth image (S34).

In an embodiment, the label ID matching may be performed by matching label centers at which a distance between a center label stored in the previous frame of the depth image and a center computed in the current frame is minimized.

For example, when a label ID is determined for a first frame of a depth image, the label ID is allocated as a user ID in the same manner.

In this case, according to an embodiment of the present invention, the number of users, that is, the number of label IDs, and center information of each label may be stored and used.

Subsequently, for a second frame consecutive to the first frame and subsequent frames, a distance between a label center stored in the previous frame and a label center computed in the current frame may be calculated, label centers at which the calculated distance is minimized may be matched to each other, and the matching result may be allocated as a user ID.

By updating the user ID according to the matching result, the user ID may be maintained in every frame.

In this process, according to an embodiment of the present invention, the user ID may be maintained, deleted, or allocated on the basis of a frame including the smaller one between the number of users in the previous frame and the number of users in the current frame.

That is, according to an embodiment of the present invention, when the user ID matching relationship is computed, the number of users stored in the previous frame may be different from the number of users input in the current frame, and thus the matching relationship is to be found on the basis of the smaller number.

For example, the number of users in the previous frame being smaller refers to the addition of new users in the current frame. Thus, the minimum distance matching relationship is found on the basis of the value of the previous frame, and a vacant new user ID is allocated to an unmatched user.

On the contrary, the number of users in the previous frame being greater refers to the disappearance of some users from the current frame. Thus, the matching relationship is found in the current frame on the basis of the label center, the user ID is maintained, and unmatched pieces of the previous data are deleted.

Subsequently, the motion recognition method according to an embodiment of the present invention includes reducing data by performing volume sampling on the depth image (S35).

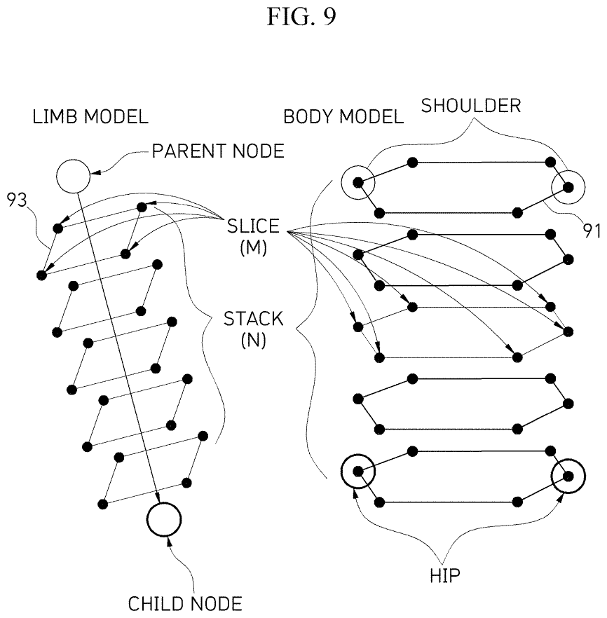

FIG. 8 is an exemplary diagram illustrating a volume sampling process.

The volume sampling process includes configuring a volume 81 (e.g., a rectangular box) in a user area of a depth image and splitting the volume 81 into a plurality of voxel units (e.g., hexahedron cubes) with a certain size.

Subsequently, the volume sampling process includes averaging values of the user depth data included in the same voxel among the plurality of voxels and applying the average value as the user depth data.

After passing through the volume sampling process, it is possible to reduce the user depth data, and it also is possible to acquire IDs and sampling data of K users.

A point in the rectangular box volume 81 in FIG. 8 shows a sampling result.

Referring to FIG. 3 again, the motion recognition method includes extracting a joint position of the user depth data on the basis of a result of matching the label ID and performing the sampling process (S36).

In this case, according to an embodiment of the present invention, a user's joint may be tracked through articulated-ICP-based model-point matching. However, unlike the conventional ICP matching, joints are classified into three parts, i.e., a head part, a body part, and a limb part, and appropriate models are applied to the parts to perform accurate and fast joint tracking compared to the conventional technique.

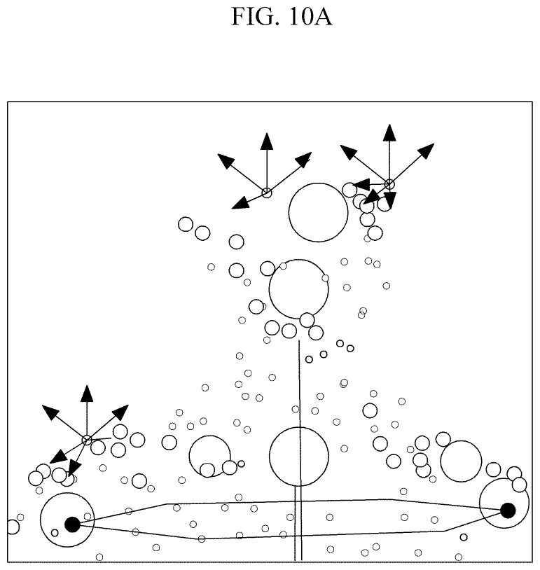

FIG. 9 is a diagram showing an example of a limb part model 93 and a body part model 91.

That is, according to the conventional ICP matching, a matching relationship for the body part 91 having the most data is found first. In this case, when body points are mismatched, mismatching occurs for limb parts.

In order to prevent such errors from accumulating, according to an embodiment of the present invention, a user area included in a user's depth data is classified into a head part, a body part, and a limb part, and the head part and a face joint are found first. Subsequently, a shoulder position is determined from a face position, and thus the matching of the body part 91 is performed on the basis of the shoulder position.

First, a process of tracking a joint position of the head part among the classified parts will be described as follows.

Since the user's head point is present on the top in the start process, points are present near the head point, but no points are present above the head point due to the nature of the head. Thus, only points matching this attribute are extracted from among sample points.

For example, in the above-described sampling operation, the sampling data is generated based on voxel data. Accordingly, when it is assumed that a total of 26 voxels are present near the current data (nine voxels in an upper portion, eight voxels in a middle portion (excluding the current voxel), and nine voxels in a lower portion), some points are present in the middle and lower portions among the 26 voxels, and nine or less (≤2) points in the upper portion are extracted.

Through this process, the top points of the head are mainly extracted, but points positioned at an arm part may be extracted when an arm is lifted. Among the points, feature points corresponding to a head may be selected to compute a head joint.

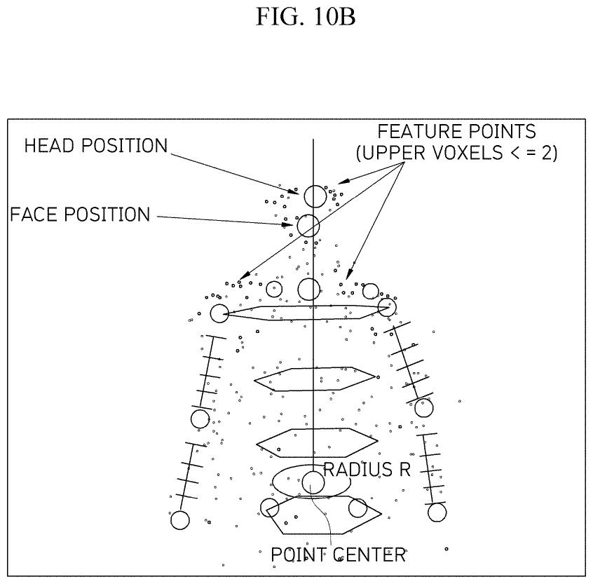

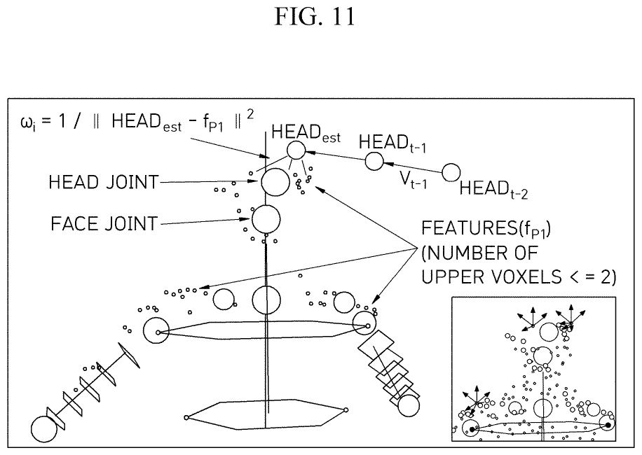

FIG. 10A and 10B is an exemplary diagram of a result of extracting feature points. FIG. 11 is a diagram illustrating a method of predicting a head part position.

For example, referring to FIG. 10A and 10BA, it can be seen that orange points are present in the middle and lower portions and two or less (X≤2) points are present in the blue upper portion.

In detail, in order to track a joint position of the head part, points positioned within a specific height range are weighted among points within a preset radius R from a human sampling point center in the first frame of the depth image.

Also, the average of the weighted points is calculated, and the average position is set as the joint position of the head part.

Referring to FIG. 10A and 10BB, it can be seen from a result of extracting points (feature points) that points are mainly present in a head position and a shoulder portion, and the joint position of the head part can be set using the corresponding result.

Subsequently, for the second frame consecutive to the first frame and subsequent frames, a position predicted based on the speed of the joint position of the head part may be set using Equation 1 below, and the weighted average of the predicted position and points positioned within a preset range may be calculated. Also, the joint position of the head part may be extracted based on the calculation result.

$${Head}_{est} = {Head}_{t - 1} + {v}_{t - 1} \\ {w}_{i} = {( {Head}_{est} + {f}_{pi} )}^{- 2} \\ {Head}_{t} = \frac{1}{w} {\sum }_{t = 0}^{m} {w}_{i} \cdot {f}_{pi} \\ w = \sum {f}_{pi} \qquad [ Equation 1 ]$$

Meanwhile, according to an embodiment, after the joint position of the head part is determined, the face position may be determined. To this end, points included in the face area may be extracted from the joint position of the head part, and the extracted points may be averaged to determine the face position.

Also, according to an embodiment of the present invention, after the face position is determined, a neck position may be determined from the face position. That is, a position corresponding to a neck may be acquired by extracting points corresponding to the length from the face position to the shoulder center and averaging the extracted points.

In this case, according to an embodiment, when the shoulder position and the neck position are acquired, anthropometric data may be utilized as the face area, the length to the shoulder center, and other sizes of the body.

According to an embodiment of the present invention, after the joint position of the head part, the face position, and the neck position are determined, the shoulder position may be determined based on the above determination.

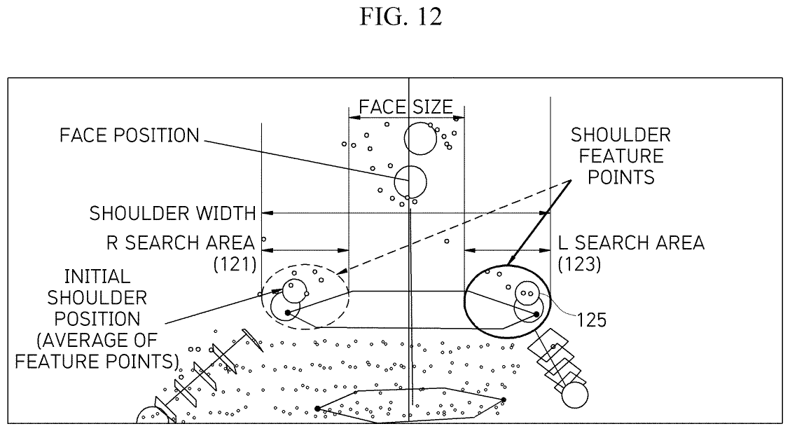

FIG. 12 is a diagram illustrating details of determining a shoulder position.

In detail, points positioned under the face position, farther away from a size of the face, and within a distance of the shoulder width are extracted from among the feature points P_{{f}}. That is, in FIG. 12, points positioned in a left purple search area 121 and a left green detection area 123 are extracted.

Also, the extracted points are classified into left and right points and then averaged to set an initial should position. In FIG. 12, it can be seen that the position 125 of a red circular area is set as the initial shoulder position.

Meanwhile, actually, the shoulder joint is somewhat lower than the initial shoulder position, and thus the shoulder position may be determined by shifting the initial shoulder position by a predetermined value in the direction of a vector connected to the face position and the neck position.

Subsequently, after the shoulder position is determined, matching is performed on a body part on the basis of the shoulder position.

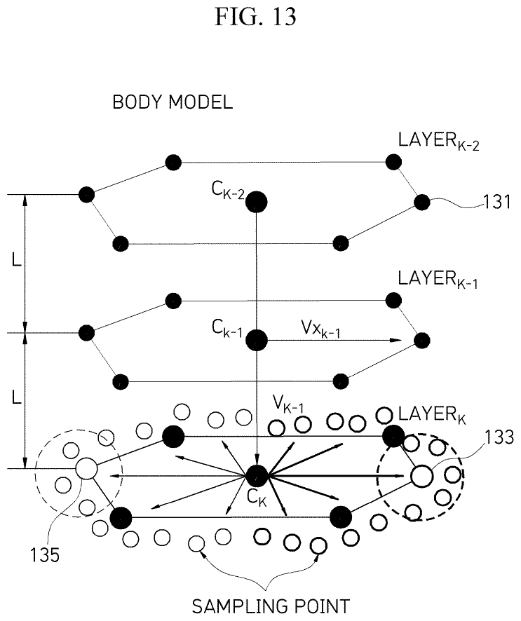

FIG. 13 is a diagram illustrating a plurality of layers 131 in a body part.

First, a body part model including a plurality of (e.g., M) layers 131 is created. In this case, the number M of layers 131 may be arbitrarily set according to an embodiment. In an example of FIG. 9, the number M is set to four. In this case, a distance between the layers is a body size divided by M−1.

Subsequently, the center of the first layer among the plurality of layers 131 is matched to the center of the shoulder position. Also, for the second layer and subsequent layers among the plurality of layers 131, a point positioned closest to the center position of the previous layers with respect to the X-axis (Vxₖ₋₁) is calculated.

For example, the center position of the second layer is chosen using a face-head vector, and the center positions of the third layer and the subsequent layers are chosen using a vector Vₖ₋₁ connecting the centers of the previous two layers. Then, when points positioned closest to the center position with respect to the X-axis Vxₖ₋₁of the upper layer are calculated, two points 133 and 135 may be found on both sides as shown in FIG. 13, and the details thereof are as shown in Equation 2 below.

Vₖ₋₁=Normal(Cₖ₋₁−Cₖ₋₂)

Cₖ=Cₖ₋₁+(L×Vₖ₋₁)

value=(Pᵢ−Cₖ)·Vₖ₋₁ [Equation 2]

if (value>0) then P_{L}=Avg(Max({P₁}))

else P_{R}=Avg(Min({P₁}))

In Equation 2 above, value is a value calculated by the dot product with the reference vector Vₖ₋₁, a positive (+) value refers to a point in the same direction, and a negative (−) value refers to a point in the opposite direction.

Also, Max({Pᵢ}) refers to a set of n points corresponding to the maximum (+) value, and Min({Pᵢ}) refers to a set of n points corresponding to the minimum (−) value.

Also, Avg( )refers to the average of the points collected as the maximum value and the minimum value.

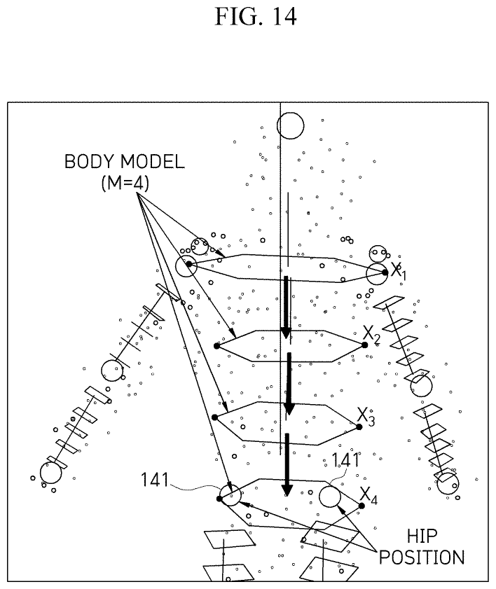

When points are collected by calculating up to the last M^{th} layer in the above manner using Equation 2 above, the direction and center of the body may be calculated. As shown in FIG. 14, the left and right positions 141 of the last layer among the plurality of layers may be set as a hip position.

FIG. 14 is a diagram illustrating a hip position.

In this case, as shown in FIG. 14, in the body part model including four layers, red indicates a positive (+) direction, green indicates a negative (−) direction, and the position of the last layer is the hip position 141.

When the shoulder position and the hip position are determined by the above method, limb parts may be tracked and then matched to the body part.

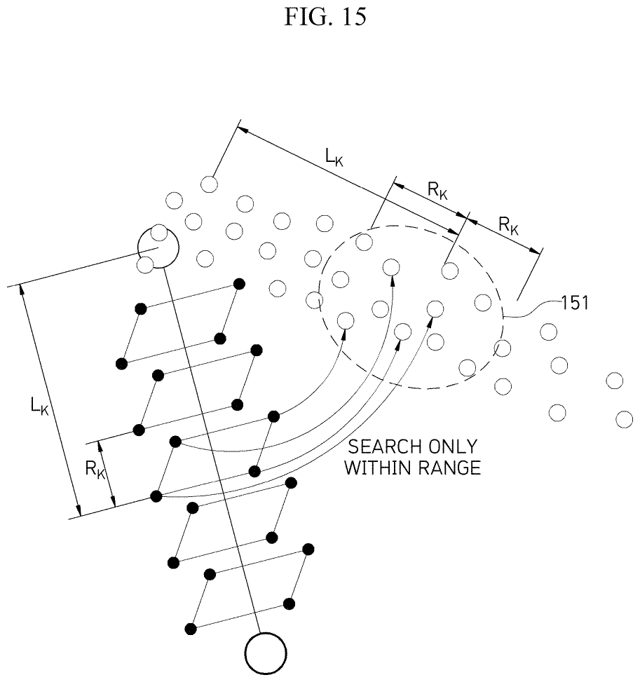

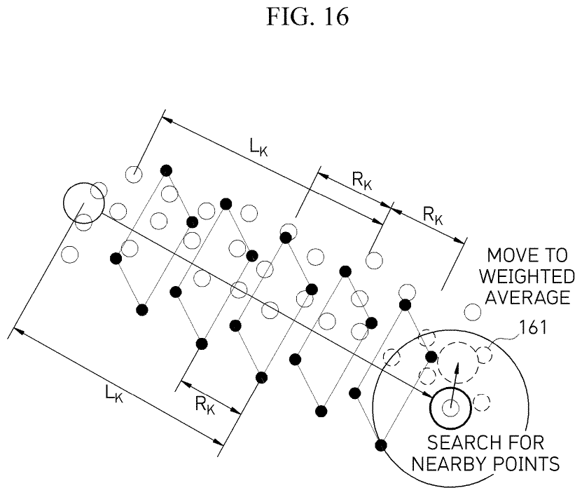

FIG. 15 is a diagram illustrating a point search process using an ICP algorithm. FIG. 16 is a diagram illustrating an operation of determining a joint position by repeating an ICP algorithm multiple times.

In general, it takes a long time for the ICP algorithm to find a matching relationship between points, and real-time processing is often difficult.

In order to solve this problem, according to an embodiment of the present invention, a detection area 151 is set based on a joint connection relationship as shown in FIG. 15. When such a detection area 151 is set, it is possible to find fast and accurate matching relationships because a search range is reduced, and thus it is advantageous in real-time processing.

Also, the ICP algorithm uses a scheme of reducing a matching error by several repetitions. According to an embodiment of the present invention, the number of repetitions is limited to “n” or less for the purpose of speed improvement. As shown in FIG. 16, when a model moves to the vicinity, a search for a nearby joint point may be performed again to determine a joint position. For example, after a re-search for a nearby point is performed, it may be determined that the joint position is moved to a portion 161 with the weighted average.

According to an embodiment of the present invention, it is possible to reduce the amount of computation by reducing the number of repetitions, and also it is possible to search for points to find an accurate joint position.

In an embodiment, in order to prevent limb parts from being affected by the body part, a force pushing outward from the point of the body part layer may be applied so that points other than the body can be followed well.

Meanwhile, in the above description, operations S31 to S36 may be divided into additional operations or combined into a smaller number of operations depending on the implementation of the present invention. Also, if necessary, some of the operations may be omitted, or the operations may be performed in an order different from that described above. Furthermore, although not described here, the above description with reference to FIGS. 1 and 2 may apply to the motion recognition method of FIG. 16.

According to the above-described embodiment of the present invention, it is possible to track a user ID and estimate a joint position using only a multi-depth image, and thus it is possible to minimize restrictions on the performance, number, and the like of depth sensors.

In addition, by distinguishing a head part, a body part, and a limb part and sequentially performing computation, rather than by applying a method of computing the entire body at once or computing a body part having a lot of data as in the conventional ICP, it is possible to reduce the amount of computation and also to accurately extract a shoulder position and a hip position, and thus ICP computation can be accurately and quickly conducted in limb joints.

Also, it is possible to increase the search speed due to the designation of the detection area in the ICP algorithm, which may require a long time, and also it is possible to increase the accuracy of the joint tracking while reducing the number of repetitions of the ICP algorithm due to a search for nearby points.

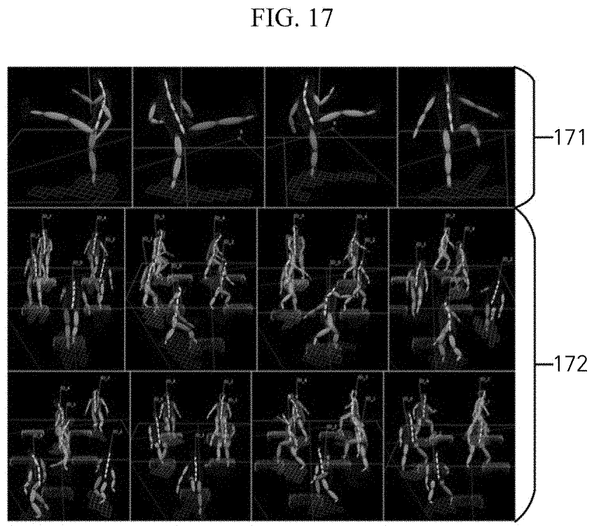

FIG. 17 is a diagram showing an example of a result of recognizing a user's motion.

FIG. 17 shows a result of recognizing a motion of rotating and moving back and forth or left and right. In FIG. 17, an upper portion 171 shows a posture estimation result for one person, and a lower portion 172 shows a posture estimation result obtained by tracking IDs of five people.

An embodiment of the present invention may be implemented as a computer program stored in a computer-executable medium or a recording medium including computer-executable instructions. A computer-readable medium may be any available medium accessible by a computer and may include volatile and non-volatile media and discrete and integrated media. Also, a computer-readable medium may include both a computer storage medium and a communication medium. The computer storage medium includes volatile and non-volatile media and discrete and integrated media which are implemented in any method or technique for storing information such as computer-readable instructions, data structures, program modules, or other data. Typically, the communication medium includes computer-readable instructions, data structures, program modules, or other data of a modulated data signal such as a carrier or other transmission mechanisms and further includes any information transmission medium.

While the method and system of the present invention are described with reference to specific embodiments, some or all of their elements or operations may be implemented using a computer system having a general-purpose hardware architecture.

The above description of the present invention is merely illustrative, and those skilled in the art should understand that various changes in form and details may be made therein without departing from the technical spirit or essential features of the invention. Therefore, the above embodiments are to be regarded as illustrative rather than restrictive. For example, each element described as a single element may be implemented in a distributed manner, and similarly, elements described as being distributed may also be implemented in a combined manner.

The scope of the present invention is shown by the following claims rather than the foregoing detailed description, and all changes or modifications derived from the meaning and scope of the claims and their equivalents should be construed as being included in the scope of the present invention.

What is claimed is:

1. A method of recognizing motions of a plurality of users through a motion recognition apparatus, the method comprising:
acquiring a plurality of depth images from a plurality of depth sensors disposed at different positions;
extracting user depth data corresponding to a user area from each of the plurality of depth images;
allocating a label ID to the extracted user depth data on a user basis;
matching the label ID for each frame of the depth images; and
tracking a joint position for the user depth data on the basis of a result of the matching.

2. The method of claim 1, wherein the acquiring of a plurality of depth images comprises correcting tilting of the depth sensors on the basis of ground depth data.

3. The method of claim 1, wherein the acquiring of a plurality of depth images comprises matching coordinate systems of the plurality of depth sensors to a coordinate system of any one of the depth sensors through computation of a translation and rotation matrix.

4. The method of claim 1, wherein the allocating of a label ID to the extracted user depth data on a user basis comprises:
splitting a ground surface into a plurality of grids;
projecting points of the user depth data onto the ground surface;
allocating the points to corresponding grids when the points are projected onto the ground surface;
storing grids including the points in a queue storage; and
allocating the same label ID to the grids stored in the queue storage.

5. The method of claim 4, wherein the storing of grids including the points in a queue storage comprises:
storing, in the queue storage, a grid including a point among grids adjacent to the grids stored in the queue storage; and
searching for a subsequent grid when a search for all the grids included in the queue storage is completed.

6. The method of claim 1, wherein the matching of the label ID for each frame of the depth images comprises matching the label ID by matching label centers to each other such that a distance between a center label stored in a previous frame of the depth image and a center calculated in a current frame is minimized.

7. The method of claim 6, wherein the matching of the label ID for each frame of the depth images comprises:
allocating a label ID of a user to a first frame of the depth images as a user ID;
storing center information of each label and the number of label IDs in the first frame;
calculating a distance between a label center stored in a previous frame and a label center computed in a current frame for a second frame consecutive to the first frame and subsequent frames; and
matching label centers to each other such that the calculated distance is minimized to perform allocation as the user ID.

8. The method of claim 7, wherein the user ID is maintained, deleted, or allocated on the basis of a frame including a smaller number of users between the number of users in the previous frame and the number of users in the current frame.

9. The method of claim 1, further comprising performing volume sampling on the depth images to reduce data.

10. The method of claim 9, wherein the performing of volume sampling on the depth images to reduce data comprises:
configuring a volume of a user area in the depth images;
dividing the volume into a plurality of voxels having a certain size;
averaging values of the user depth data included in the same voxel among the plurality of voxels; and
applying the average value to the user depth data.

11. The method of claim 1, wherein the tracking of a joint position for the user depth data on the basis of a result of the matching comprises:
distinguishing a user area included in the user depth data into a head part, a body part, and a limb part;
tracking a joint position of the head part among the parts;
determining a shoulder position from the tracked joint position of the head part;
matching the body part to the shoulder position; and
tracking the limb part and then matching the limb part to the body part.

12. The method of claim 11, wherein the tracking of a joint position of the head part among the parts comprises:
weighting points positioned in a specific height range among points within a predetermined radius from a center of the first frame of the depth image;
calculating the average of the weighted points and setting an average position to the joint position of the head part;
setting a predicted position on the basis of speed of the joint position of the head part for a second frame consecutive to the first frame and subsequent frames;
calculating a weighted average of points positioned at the predicted position and positioned within a predetermined range; and
tracking the joint position of the head part on the basis of a result of the calculation.

13. The method of claim 11, wherein the tracking of a joint position of the head part among the parts comprises:
extracting points included in a face area from the joint position of the head part; and
determining a face position by averaging the extracted points.

14. The method of claim 13, wherein the tracking of a joint position of the head part among the parts comprises:
extracting points corresponding to a length from the face position to a shoulder center; and
determining a neck position by averaging the extracted points.

15. The method of claim 14, wherein the determining of a shoulder position from the tracked joint position of the head part comprises:
extracting points positioned under the face position and positioned farther away from a size of the face and within a distance of a shoulder width;
classifying the extracted points into left and right points and setting an initial shoulder position through averaging; and
determining the shoulder position by shifting the initial shoulder position by a certain value in a direction of a vector connected to the face position and the neck position.

16. The method of claim 15, wherein the matching of the body part to the shoulder position comprises:
creating a body part model including a plurality of layers;
matching a center of a first layer among the plurality of layers to a center of the shoulder position;
calculating points closest to center positions of previous layers with respect to an x-axis for a second layer and subsequent layers among the plurality of layers; and
collecting the calculated points to calculate a direction and a center of a body.

17. The method of claim 16, wherein the tracking of a joint position of the head part among the parts comprises setting, as a hip position, left and right positions of the last layer among the plurality of layers.

18. The method of claim 17, the tracking of the limb part and then the matching of the limb part to the body part comprises:
setting the detection area on the basis of a joint connection relationship; and
detecting a matching relationship between a point and the body part model for the detection area on the basis of an articulated-ICP algorithm.

19. An apparatus for recognizing motions of a plurality of users, the apparatus comprising:
a plurality of depth sensors disposed at different positions and configured to acquire a depth image;
a memory configured to store a program for recognizing a user's motion from the plurality of depth images; and
a processor configured to execute the program stored in the memory,
wherein by executing the program stored in the memory, the processor extracts user depth data corresponding to a user area from each of the plurality of depth images, allocates a label ID to the extracted user depth data on a user basis, matches the label ID for each frame of the depth images, and tracks a joint position of the user depth data on the basis of a result of the matching.

20. A system for recognizing motions of a plurality of users, the system comprising:
a sensor unit configured to acquire a plurality of depth images from a plurality of depth sensors disposed at different positions and extract user depth data corresponding to a user area from each of the plurality of depth images;
an ID tracking unit configured to allocate a label ID to the extracted user depth data on a user basis and match the label ID for each frame of the depth images; and
a 3D motion recognition unit configured to track a joint position of the user depth data in the order of a head part, a body part, and a limb part on the basis of a result of the matching.
